(19) United States
(12) Patent Application Publication
(10) Pub. No.: US 2002/0021355 A1
(43) Pub. Date: Feb. 21, 2002

(54) Video endoscope system

(75) Inventors: Tetsuya Utsui, Saitama-ken (JP); Koichi Furusawa, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/919,969

(22) Filed: Aug. 2, 2001

(30) Foreign Application Priority Data
Aug. 8, 2000 (JP) P2000-239924

(51) Int. Cl. H04N 7/18

(52) U.S. Cl. 348/65

(57) ABSTRACT

The light source device has a wheel holding a blue filter, a green filter, a red filter, and a transparent member so as to sequentially and repeatedly introduce blue light, green light, red light and excitation light into an illumination optical system of an endoscope. An objective lens of the endoscope forms an image of a subject irradiated with the above light. An imaging device converts the image of the subject into an image signal. A video processor receives this image signal and generates normal image data and fluorescence image data, which are to display the image as moving picture. Furthermore, a PC executes image processing to extract a specific region having an illuminance value within a predetermined range from fluorescence image data, thereby generating diagnostic image data to display a diagnostic image in which that portion of the normal image data corresponding to the specific region is shown in blue.

### BACKGROUND OF THE INVENTION

1. Field of the Invention

The present invention relates to a video endoscope system for obtaining images of the interior of a hollow organ within a living body formed from autofluorescence of living tissue, which is used in diagnosis to determine whether the living tissue is normal or not. The present disclosure relates to subject matter contained in Japanese Patent Application No. 2000-239924 (filed on Aug. 8, 2000), which is expressly incorporated herein by reference in its entirely

2. Description of the Related Art

Video endoscope systems are used for observation of hollow organs or other internal areas of a living body. These video endoscope systems have illumination optical systems for illumination, objective optical systems for forming images, and imaging devices for picking up the images. The illumination optical system applies visible light to living tissue. Reflected light of the visible light from the living tissue is focused by the objective optical system to form images of the surface of the living tissue near an imaging surface of the imaging device. The imaging device then outputs an image signal that indicates an image (normal image) of the surface of the living tissue. Based on this image data, video images are displayed on a monitor. This configuration allows an operator to observe the interior of the living body by viewing the normal images displayed on the monitor. For example, if living tissue is morphologically abnormal, the operator can detect this abnormality on the basis of the normal image. However, minute morphological abnormalities often cannot be detected by the operator based on the normal images. For this reason, video endoscope system for fluorescence diagnosis have been developed to detect abnormal conditions of living tissue, using fluorescence (autofluorescence) caused from the living tissue under predetermined conditions. Autofluorescence is emitted from the living tissue when it irradiated with excitation light. The fluorescence diagnosis takes advantage of the fact that the emission intensity of a green light region of the autofluorescence is higher in normal tissue than in abnormal tissue (for example, tumors or cancerous tissue).

These video endoscope systems for fluorescence diagnosis have light source devices for selectively emitting visible light and excitation light to guide them to the illumination optical system. Under normal observation status, the light source device emits visible light, so that the objective optical system forms an image from light reflected by the surface of living tissue, and the imaging device subsequently outputting an image signal showing a normal image of the living tissue as moving picture. In contrast, when the operator depresses an external switch or similar device, the light source device emits excitation light to irradiate the living tissue, causing it to emit autofluorescence. The objective optical system then forms an image of the tissue from the autofluorescence, and the imaging device outputs an image signal showing a fluorescence image. Thus, these video endoscope system can normally display an image of the subject as a moving picture on the monitor and, when the external switch is depressed, they can display a stationary fluorescence image of the subject as a still on the monitor.

Using such a video endoscope system, the operator first observes the interior of the living body while viewing the normal image displayed as a moving picture. On finding a tumor or a site that appears abnormal, the operator depresses the external switch to obtain a still fluorescence image. In the fluorescence image, diseased tissue appears darker than normal tissue, allowing more certain detection.

These video endoscope systems display normal images as moving pictures, but cannot display fluorescence images as moving picture. Therefore, the operator performs normal inspection of the interior of the living body over a wide range by moving the imaging range of the video endoscope system. On the other hand, since the fluorescence image is only a still image, the operator searches for suspected sites through normal observation procedures, then performs fluorescence observations on these sites on the basis its still fluorescent images. Therefore, fluorescence observation is not performed for the sites overlooked during the normal observations.

### SUMMARY OF THE INVENTION

It is an object of the present invention to provide a video endoscope system that produces video images not only for normal images but also for fluorescence images, to enable wide-ranging normal and fluorescence observations of the interior of a living body.

The video endoscope system according to the present invention has an illumination optical system for illuminating a subject, a light source device for emitting visible light and excitation light that excites living tissue to cause fluorescence and for alternately switching between the visible light and the excitation light to introduce them into the illumination optical system, an objective optical system for focusing those components of light from a surface of the subject other than the excitation light to form an image of the surface of the subject, an imaging device for picking up the image formed by the objective optical system to convert it into an image signal, and an image processor for generating normal image data to display a normal image of the subject as a moving picture, based on a portion of the image signal corresponding to the period in which the visible light is introduced into the illumination optical system and for generating fluorescence image data to display a fluorescent image of the subject as a moving picture, based on a portion of the image signal corresponding to a period in which the excitation light is introduced into the illumination optical system.

In this configuration, the subject is illuminated with the visible light when the light source device emits the visible light. The visible light reflected by the surface of the subject and then focused by the objective optical system forms a normal image of the subject. This normal image is converted by the imaging device into an image signal. On the basis of this image signal, the image process generates normal image data to display the normal image as a moving picture. Likewise, the subject is illuminated with excitation light when the light source device emits the excitation light. Living tissue is thereby excited by the excitation light to cause autofluorescence. This autofluorescence and the excitation light reflected by the surface of the subject are incident on the objective optical system. This objective optical system blocks the excitation light and focuses the autofluorescence to form an autofluorescence image. This autofluorescence image is converted by the imaging device into an image signal. On the basis of this image signal, the image processor generates fluorescence image data to display a fluorescent image of the subject as a moving picture.

The light source device may have a visible light source for emitting the visible light, an excitation light source for emitting the excitation light, and a light source switching section for alternately switching between visible light emitted from the visible light source and the excitation light emitted from the excitation light source to introduce them into the illumination optical system. As the light source switching section switches the visible and excitation lights at predetermined intervals, so the normal image and the fluorescence image are displayed simultaneously.

This light source switching section can be implemented with a configuration using a pair of shutters that can individually block visible and excitation light. It can also be implemented with a rotating wheel inserted at an intersection of the visible light and the excitation light. This rotating wheel guides visible light to the illumination optical system with one part of itself and guides the excitation light to the illumination optical system with another part of itself. When the rotating wheel rotates, visible light and excitation light are sequentially and repeatedly introduced into the illumination optical system.

The image processor may extract a specific region having an illuminance value within a predetermined range from fluorescence image data to generate diagnosis image data showing the specific region. Moreover, the diagnosis image data may be generated so that the portion of the data corresponding to the specific region is shown in a predetermined color. This enables the operator to easily and accurately recognize the specific region displayed on the monitor in a predetermined color.

The visible light source of the light equipment may be a white light source that emits white light. In this case, the light source device further has a wheel shaped in a disc and holding a blue filter transmitting only blue light, a green filter transmitting only green light, a red filter transmitting only red light and a transparent member transmitting at least the excitation light, along its circumference, and a driving section for rotating the wheel so that the filters held on the wheel are sequentially inserted into the optical path between the light source switching section and the illumination optical system while the light source switching section is switching to the white light and the transparent member held on the wheel is inserted into the optical path while the light source switching section is switching to the excitation light.

In this configuration, the light source device sequentially and repeatedly introduce blue, green, red, and excitation light into the illuminating optical system as the wheel is rotated. This simple configuration provides illuminating light with which a normal color image and a fluorescence image can be obtained.

Further, in this case the image processor may generate reference image data based on image signal obtained by the imaging device while the red filter held on the wheel is inserted into the optical path, extract a particular region having an illuminance value equal to or greater than a first threshold from the reference image data, extract a specific region of the fluorescence image data that corresponds to the particular region and having an illuminance value smaller than a second threshold and greater than the first threshold, and generate diagnosis image data to display a diagnostic image in which a portion of the normal image data corresponding to the above mentioned specific region is shown in a predetermined color.

This configuration enables the red light, which is unlikely to be affected by living tissue or blood, to be used as reference light. And since reference image data is extracted from a image signal for the normal image data, the transparent member can occupy a wide area of the wheel. This increases the accumulating time for charges induced by the autofluorescence in the imaging device.

### BRIEF DESCRIPTION OF THE DRAWINGS

The invention will be described below in detail with reference to the accompanying drawings in which:

FIG. 1 is a schematic illustration showing an internal structure of a video endoscope system according to a first embodiment of the present invention;

FIG. 2 is a front view of a wheel;

FIG. 3 is a timing chart for illuminating lights and shutters;

FIG. 4 is a block diagram showing the configuration of a personal computer;

FIG. 5 is a flowchart showing processing executed by a CPU;

FIG. 6 is a view showing an example of a normal observation image;

FIG. 7 is a graph showing an illuminance distribution in the normal observation image;

FIG. 8 is a view showing an example of a normal observation image obtained after binarization based on the first threshold;

FIG. 9 is a graph showing an illuminance distribution in the normal observation image obtained after binarization based on the first threshold;

FIG. 10 is a graph showing an illuminance distribution in an autofluorescence image;

FIG. 11 is a view showing an example of an autofluorescence image obtained after a logical AND process;

FIG. 12 is a graph showing an illuminance distribution in the autofluorescence image obtained after the logical AND process;

FIG. 13 is a view showing an example of an autofluorescence image obtained after binarization based on the second threshold;

FIG. 14 is a graph showing an illuminance distribution in the autofluorescence image obtained after the binarization based on the second threshold;

FIG. 15 is a view showing an example of an image displayed on a monitor;

FIG. 16 is a view showing a structure of a light source device according to the second embodiment of the present invention;

FIG. 17 is a front view of an optical-path switching wheel;

FIG. 18 is a timing chart for illuminating lights and the optical-path switching wheel; and

FIG. 19 is a front view showing a variation of the optical-path switching wheel.

### DETAILED DESCRIPTION OF THE INVENTION

Embodiments of the present invention will be described below, referring to the drawings.

### First Embodiment

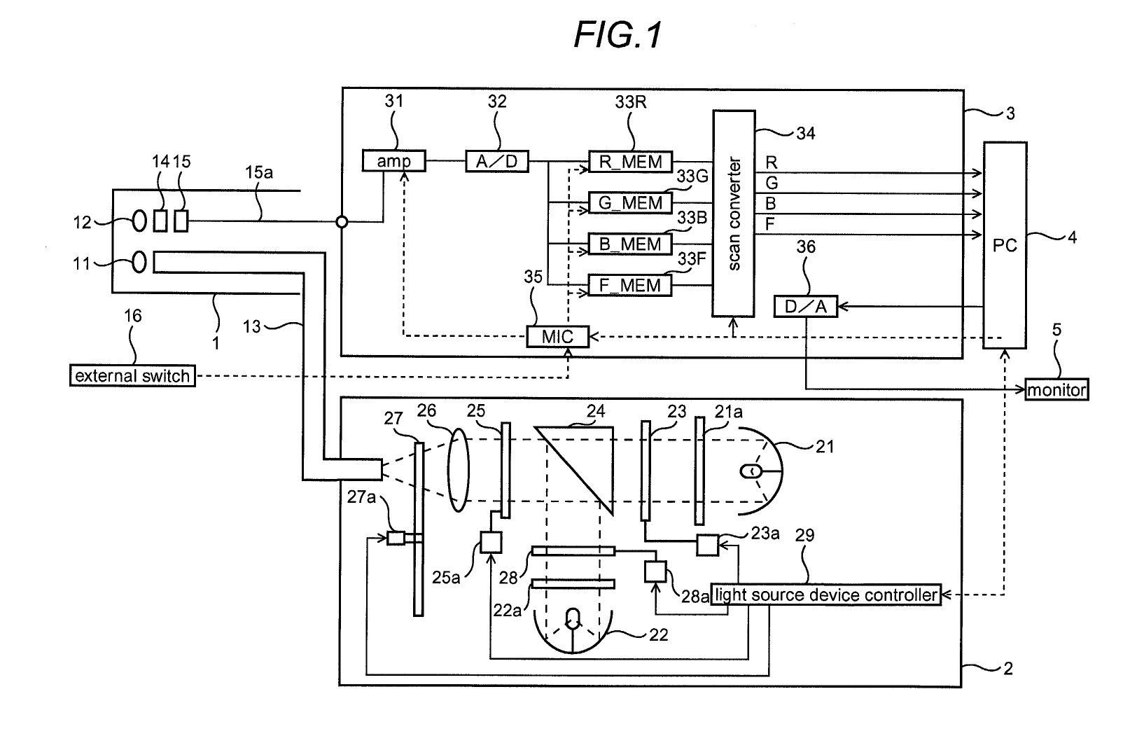

FIG. 1 is a schematic view showing a video endoscope system according to a first embodiment. As shown in this figure, the video endoscope system has a video endoscope 1, a light source device 2, a video processor 3, a personal computer (PC) 4 and a monitor 5. The video processor 3 and the PC 4 functions as the image processor.

The video endoscope (hereafter simply referred to as the “endoscope”) 1 has an insertion tube formed as a flexible tube, which is to be inserted into a living body. However, FIG. 1 does not illustrate the shape of the endoscope 1 in detail. The insertion tube has a bending mechanism built in a portion near its distal end which is capped with a tip member made of a hard material. To the proximal end of the inserted tube, an operating section is connected. The operating section has a dial for operating the bending mechanism to bend and various operating switches. The endoscope 1 has at least two through-holes drilled in the tip member, in which a light distribution lens 11 and an objective lens 12 are respectively provided. The endoscope 1 also has a light guide 13 consisting of many multimode optical fibers bundled together. The light guide 13 is led through the endoscope 1 with its distal end face opposing to the light distribution lens 11. A proximal face of the light guide 13 is connectable to the light source device 2. The light distribution lens 11 and the light guide 13 function as the illumination optical system. The endoscope 1 also has an excitation light cut-off filter 14 and an imaging device 15. The imaging device 15 is a CCD having an imaging surface arranged at a location where the objective lens 12 forms an image of a subject in examination when the distal end of the insertion tube faces the subject. The excitation light cut-off filter 14 blocks excitation light, described further below. The excitation light cut-off filter 14 is disposed in an optical path between the objective lens 12 and the imaging device 15. The objective lens 12 and the excitation light cut-off filter 14 function as the objective optical system.

The light source device 2 has a white light source 21 for emitting white light and an excitation light source 22 for emitting excitation light. The excitation light includes an ultraviolet light and is used to excite living tissue to cause autofluorescence. The white light source 21 consists of a lamp radiating the white light and a reflector reflecting the white light radiated by the lamp as collimated light. The white light source 21 also has an infrared cut-off filter 21a. The infrared cut-off filter 21a blocks wavelength components of an infrared region contained in the white light reflected by the reflector while transmitting wavelength components of a visible region. Along the optical path of the white light transmitted through the infrared cut-off filter 21a are arranged a first shutter 23, a prism 24, a diaphragm 25, a condenser lens 26 and a rotating wheel 27 in this order. The first shutter 23 is connected to a first shutter-driving section 23a. The shutter-driving section 23a includes a solenoid to move the first shutter 23 between a blocking position in which it blocks the white light transmitted through the infrared cut-off filter 21a and a retracted position in which it retracts from the optical path of the white light. When the first shutter 23 is in the retracted position, the white light transmitted through the infrared cut-off filter 21a travels through the prism 24 to the diaphragm 25. The diaphragm 25 is connected to a diaphragm control section 25a, which can cause diaphragm 25 to vary the quantity of passing light. The amount of light passing through the aperture of the diaphragm 25 is incident on the condenser lens 26, which condenses the light onto a proximal end surface of the light guide 13. The wheel 27 is inserted into the optical path between the condenser lens 26 and the light guide 13, and is connected to a motor 27a to be rotated thereby. The structure of the wheel 27 will be described later.

On the other hand, the excitation light source section 22 consists of a lamp radiating a particular light, for example ultraviolet light, in a predetermined wavelength region containing specific wavelength available as excitation light and a reflector reflecting the particular light radiated by the lamp as collimated light. The excitation light source section 22 also has an excitation light filter 22a. The excitation light filter 22a transmits only the specific wavelength components contained in the particular light reflected by the reflector of the excitation light source section 22 that are available as excitation light. A second shutter 28 is disposed in the optical path of the excitation light transmitted through the excitation light filter 22a and connected to a second shutter-driving section 28a. The second shutter-driving section 28a includes a solenoid to move the second shutter 28 between a blocking position in which it blocks excitation light transmitted through the excitation light filter 22a and a retracted position in which it retracts from the optical path of the excitation light. When the second shutter 28 is in its retracted position, the excitation light transmitted through the excitation light filter 22a is reflected by the prism 24 and directed to the diaphragm 25. Like the case of the white light described above, the quantity of the excitation light directed to the diaphragm 25 is adjusted by the diaphragm 25. Then, the excitation light is focused onto the proximal end face of the light guide 13 by the condenser lens 26. The prism 24 and both shutters 23 and 28 function as the light source switching section.

The light source device 2 has a light source device controller 29 connected to the PC 4. The light source device controller 29 is connected to each of the shutter-driving sections 23a and 28a, the diaphragm control section 25a and a motor 27a. The light source device controller 29 controls each of the shutter-driving sections 23a and 28a to move one of them to its blocking position, at the same time moving the other to its retracted position. Moreover, the light source device controller 29 controls the diaphragm control section 25a to cause the diaphragm 25 to adjust the quantity of passing light.

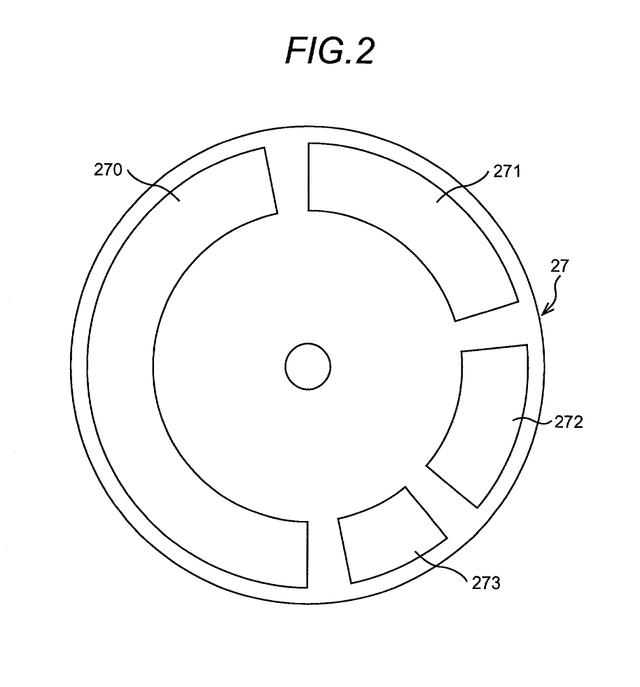

The light source device controller 29 controls the motor 27a to rotate the wheel 27, at constant speed. FIG. 2 is a front view showing structure of the wheel 27. The wheel 27 is a disk coaxially connected to a drive shaft of the motor 27a, on which four openings are formed along its circumference. Each of these openings is shaped in arc bounded by a convex arc edge on a first concentric circle having a slightly smaller radius than the outer peripheral of wheel 27, a convex arc edge on a second concentric circle coaxial with and having a smaller radius than the first concentric circle, and a pair of radial edges. Each of the openings has different size from one another with its unique circumferential length along the circumference of the wheel 27. More specifically, the left-hand opening in FIG. 2 is the largest, with the size of the other openings decreasing clockwise. From the largest to the smallest openings, the openings are filled with a transparent member 270, a blue filter 271, a green filter 272, and a red filter 273, respectively. The blue filter 271 transmits only light in blue band, green filter 272 transmits only light in green band, and red filter 273 transmits only light in red band. The transparent member 270 is made of an optical material that can transmit at least the excitation light. Driven by the motor 27a, the wheel 27 rotates around its central shaft. The wheel 27 is arranged at a location where it can sequentially insert the filters 271, 272, 273 and the transparent member 270 into the optical path of light emitted from the condenser lens 26.

In accordance with synchronization signals input by the PC 4, light source device controller 29 controls the motor 27a to rotate the wheel 27 at constant speed and controls the shutter-driving sections 23a and 28a to move the shutters 23 and 28, respectively. Specifically, the light source device controller 29 controls the shutter-driving sections 23a and 28a as follows. When one of the filter 271, 272 and 273 held on the wheel 27 is inserted into the optical path, the first shutter 23 is moved to its retracted position, while the second shutter 28 is moved to its blocking position. When the transparent member 270 is inserted into the optical path, the first shutter 23 is moved to its blocking position, while the second shutter 28 is moved to its retracted position. The light source device controller 29 and the shutter-driving sections 23a and 28a function as the switching driving mechanism. With this control, only white light travels through the optical path beyond prism 24 when one of the filters 271, 272 and 273 held on the wheel 27 is inserted into the optical path. The amount of the white light transmitted through the prism 24 as collimated beams is adjusted by the diaphragm 25 to a predetermined value. Then, the white light is condensed by the condenser lens 26, and on the way to converging, the white light reaches the wheel 27. The white light that reaches the wheel 27 is sequentially converted into blue light (B), green light (G), and red light (R) by filters 271, 272, and 273, and is then incident on the proximal end face of the light guide 13. When the transparent member 270 is inserted into the optical path, only excitation light travels through the optical path beyond the prism 24. The amount of the excitation light reflected by the prism 24 as collimated light is adjusted to the predetermined value by the diaphragm 25. Then, the excitation light is condensed by the condenser lens 26, and the way to converging, the excitation light reaches the wheel 27. The excitation light that reaches the wheel 27 is transmitted through the transparent member 270, and is then incident on the proximal end face of the light guide 13.

As described above, the blue, green, red and excitation light is repeatedly incident on the proximal end face of the light guide 13 in that sequence. The incident light is guided to the light guide 13 to be emitted through its distal end face, and illuminates the subject via the light distribution lens 11. The blue, green and red light is applied to and reflected by the subject, and is then incident on the objective lens 12. The blue, green and red light entering the objective lens 12 is transmitted in sequence through the excitation light cut-off filter 14 and forms an image of the subject on the imaging surface of the imaging device 15. The imaging device 15 converts the subject image into an image signal and transmits it to the video processor 3 via the signal line 15a. When the excitation light is applied, the living tissue irradiated with the excitation light emits autofluorescence. This autofluorescence and the excitation light reflected by the surface of the subject are incident on the objective lens 12. Then, the excitation light cut-off filter 14 transmits only the autofluorescence and blocks the excitation light. The autofluorescence transmitted through the excitation light cut-off filter 14 forms an image of the subject on the imaging surface of the imaging device 15. The imaging device 15 converts the subject image into an image signal and transmits it to the video processor 3 via the signal line 15a. As shown in FIG. 2, among the transparent member 270 and the red, green and blue filters 271, 272, and 273 held on the wheel 27, only the transparent member 270 occupies an area corresponding to almost half of the circumference of wheel 27. Thus, the excitation light is emitted for the longest period comparing with that period of blue, green and red light. This design enables the imaging device 15 to accumulate, over a relatively long period, charges associated with the autofluorescence which is fainter comparing with the reflected light from the subject. Among the remaining elements, the blue filter 271 has the largest circumferential length, the green filter 272 has the second largest circumferential length, and the red filter 273 has the third largest circumferential length. This design sets the duration for which blue light causes charges to be accumulated in the imaging device 15 for the longest time, the duration for which green light causes charges to be accumulated for the second longest time, and the duration for which red light causes charges to be accumulated for the shortest time, because sensitivity of the imaging device 15 becomes lowering in order of red light, green light and blue light.

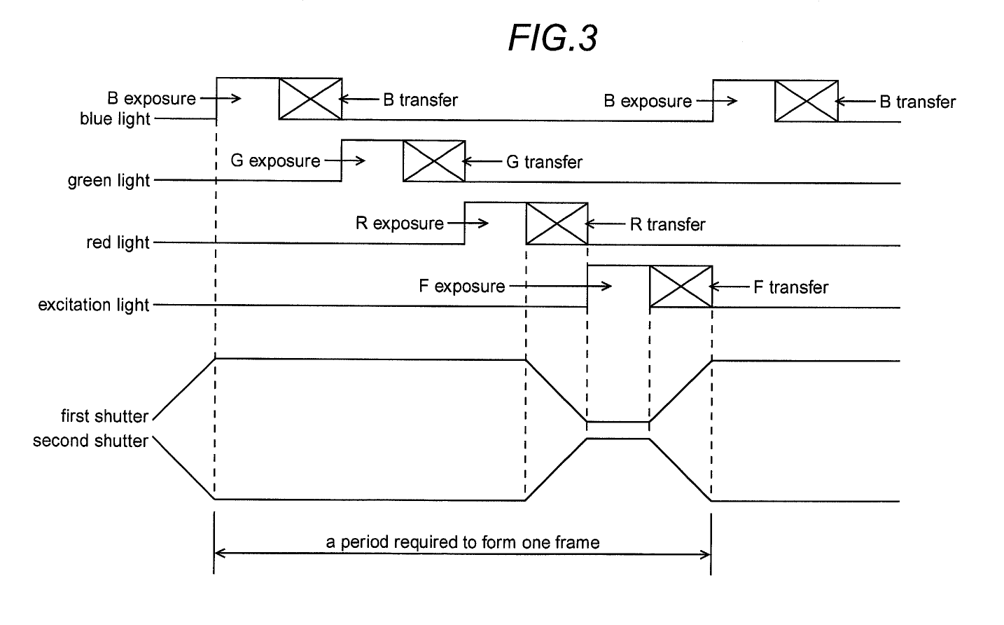

FIG. 3 is a timing chart for the illuminating light and movement of the shutters 23 and 28. Although this figure shows irradiation times for the colors of illuminating light equally for the sake of illustration, the excitation light in fact requires the longest irradiation time, the blue light requires the second longest irradiation time, the green light requires the third longest irradiation time, and the red light requires the fourth longest, or the shortest, irradiation time. As shown in FIG. 3, the first shutter 23 moves to its retracted position which is indicated with the upper portion of the chart in FIG. 3, while the second shutter 28 moves to its blocking position which is indicated with the lower portion of the chart in FIG. 3. Thereafter, the blue light is emitted through the light distribution lens 11 of the endoscope 1. The period during which the blue light is emitted corresponds to a “B exposure” period for the imaging device 15. Immediately after the “B exposure” period, the charges accumulated in imaging device 15 are transferred over a fixed transfer time, which is called a “B transfer” period. Immediately after the “B transfer” period, the green light is emitted through the light distribution lens 11. The period during which the green light is emitted corresponds to a “G exposure” period for the imaging device 15. Immediately after the “G exposure” period, the charges accumulated in the imaging device 15 are transferred over the transfer time, which is called a “G transfer” period. Immediately after the “G transfer” period, the red light is emitted through the light distribution lens 11. The period during which the red light is emitted corresponds to an “R exposure” period for the imaging device 15. Immediately after the “R exposure” period, the charges accumulated in the imaging device 15 are transferred over the transfer time, which is called an “R transfer” period. At the same time when the “R exposure” period ends, the first shutter 23 moves to its blocking position which is indicated with the lower portion of the chart in FIG. 3, while the second shutter 28 moves to its retracted position which is indicated with the upper portion of the chart in FIG. 3. The movement of the shutters 23 and 28 is completed within the “R transfer” period. Immediately after the “R transfer” period, the excitation light is emitted through the light distribution lens 11. When irradiated with the excitation light, living tissue of the subject emits auto fluorescence. An image formed from the autofluorescence is picked up by the imaging device 15. The period during which the excitation light is emitted corresponds to an “F exposure” period for the imaging device 15. Immediately after the “F exposure” period, the charges accumulated in the imaging device 15 are transferred over the transfer time, which is called an “F transfer” period. At the same time that the “F exposure” period ends, the first shutter 23 moves to its retracted position which is indicated with the upper portion of the chart in FIG. 3, while the second shutter 28 moves to its blocking position which is indicated with the lower portion of the chart in FIG. 3. The movement of the shutters 23 and 28 is completed within the “F transfer” period. The above-mentioned “B exposure” to “F transfer” periods are repeated.

The video processor 3 has an amplifier 31 connected to the signal line 15a and an A/D converter 32 connected to the amplifier 31, as shown in FIG. 1. An analog image signal transmitted from the imaging device 15 through the signal line 15a is amplified by the amplifier 31 and then converted into a digital image signal by the A/D converter 32. The video processor 3 also has an R memory 33R, a G memory 33G, a B memory 33B and an F memory 33F, and a scan converter 34. These memories 33R, 33G, 33B and 33F respectively have an input terminal connected to the A/D converter 32 and an output terminal connected to the scan converter 34. The video processor 3 also has a microcomputer (MIC) 35. The MIC 35 is connected to the amplifier 31, each of the memories 33R, 33G, 33B and 33F and the scan converter 34. The MIC 35 is also connected to an external switch 16 among the operating switches provided on the operating section of the endoscope 1 and to the PC 4. The MIC 35 varies an amplification factor of the amplifier 31 according to the synchronization signals input from the PC 4. More specifically, the MIC 35 sets a predetermined normal amplification factor to the amplifier 31 for the period from the start of the “B transfer” period to the end of the “R transfer” period shown in FIG. 3, and sets a predetermined fluorescence amplification factor for a period corresponding to the “F transfer” period shown in FIG. 3. The fluorescence amplification factor is greater than the normal amplification factor. The analog image signal amplified by the amplifier 31 is converted into a digital image signal by the A/D converter 32. The MIC 35 sequentially stores the digital image signals output from the A/D converter 32 according to the synchronization signals input from the PC 4 in the memories 33B, 33G, 33R and 33F. Specifically, the analog image signal transmitted to the amplifier 31 via the signal line 15a during the “B transfer” period shown in FIG. 3 is amplified in accordance with the normal amplification factor by the amplifier 31, and then the amplified analog image signal is converted into a digital image signal by the A/D converter 32 and stored in the B memory 33B as a blue digital image signal. Likewise, the analog image signal transmitted to the amplifier 31 via the signal line 15a during the “G transfer” period shown in FIG. 3 is amplified in accordance with the normal amplification factor by the amplifier 31, and then the amplified analog image signal is converted into a digital image signal by the A/D converter 32 and stored in the G memory 33G as a green digital image signal. Likewise, the analog image signal transmitted to the amplifier 31 via the signal line 15a during the “R transfer” period shown in FIG. 3 is amplified in accordance with the normal amplification factor by the amplifier 31, and then the amplified analog image signal is converted into a digital image signal by the A/D converter 32 and stored in the R memory 33R as a red digital image signal. On the other hand, the analog image signal transmitted to the amplifier 31 via the signal line 15a during the “F transfer” period shown in FIG. 3 is amplified in accordance with the fluorescence amplification factor by the amplifier 31, and then the amplified analog image signal is converted into a digital image signal by the A/D converter 32 and stored in the F memory 33F as a fluorescence digital image signal. According to the synchronization signals received from the PC 4, the scan converter 34 reads the digital image signals stored in the R memory 33R, the G memory 33G, the B memory 33B and the F memory 33F, and synchronously outputs them to the PC 4. The video processor 3 has a D/A converter 36 connected to the PC 4 and the monitor 5. The D/A converter 36 will be described later.

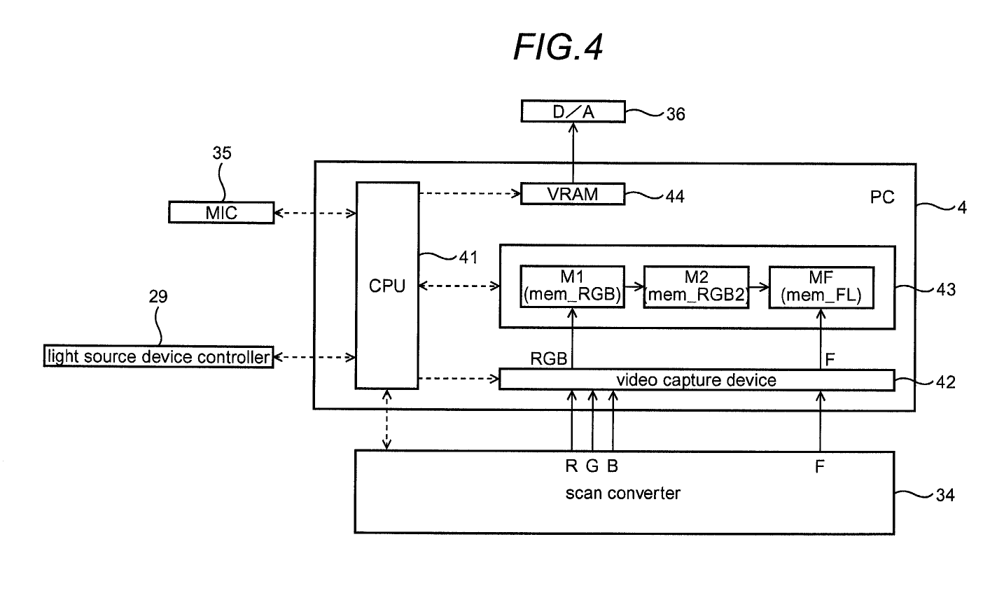

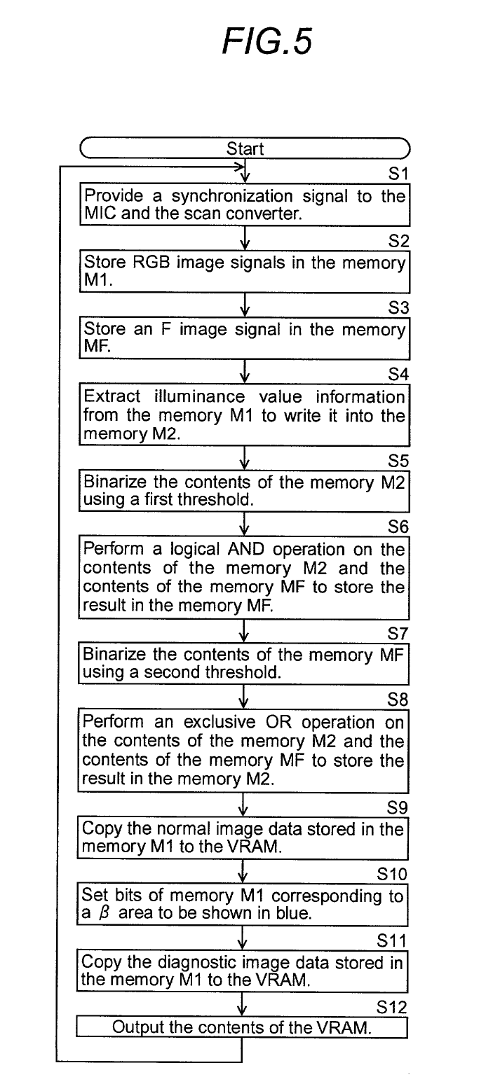

Next, the structure of PC 4 will be discussed with reference to FIG. 4. As shown in this figure, the PC 4 is configured of a CPU 41, a video-capture device 42, a memory section 43 and a VRAM 44. The CPU 41 is connected to the video capture device 42, the memory section 43 and the VRAM 44. The CPU 41 is also connected to the light source device controller 29 of the light source device 2 and to the MIC 35 and the D/A converter 36 of the video processor 3. The video capture device 42 temporarily holds the red, green, blue and fluorescence digital image signals output from the scan converter 34 of the video processor 3 and stores these signals in the memory section 43 as image data, according to instructions from the CPU 41. The memory section 43 is a RAM which includes an area as a memory M1 (mem_RGB) for storing red, green and blue digital image signals (i.e., normal image data) output from the video capture device 42, an area as a memory MF (mem_FL) for storing the fluorescence digital image signal (i.e., fluorescence image data) output from the video capture device 42, and an area as a memory M2 (mem_RGB2) used for process to create diagnosis image data which will be described later. The VRAM 44 retains image data (RGB image signal) output from the CPU 41 to be displayed on the monitor 5 and outputs the retained RGB image signal to the D/A converter 36, according to instructions from the CPU 41. The CPU 41 executes a control program stored in a ROM (not shown) to control the operations of the light source device controller 29, the MIC 35, the video capture device 42, the memory section 43 and the VRAM 44. The flow of a process executed by the CPU 41 in accordance with the control program will be described with reference to the flowchart in FIG. 5.

The process shown in FIG. 5 is started by an operator switching on a main power supply to the light source device 2, the video processor 3 and the PC 4. When the power supply to the light source device 2 is turned on, the lamps of the light sources 21 and 22 are lit. When the power supply for light source device controller 29 is turned on, the light source device controller 29 controls the motor 27a to rotate the wheel 27 at a constant speed, and also controls the shutter-driving sections 23a and 28a to operate the shutters 23 and 28. The light source device controller 29 then transmits the synchronization signal for the wheel 27 to the CPU 41. Under these conditions, the blue, green and red light and the excitation light are sequentially emitted through the light distribution lens 11 of the endoscope 1. Thus, when the inserted tube of the endoscope 1 is inserted into the living body, subjects of examination such as a hollow organ wall, are sequentially illuminated with the blue, green and red light and the excitation light. The imaging device 15 then sequentially outputs blue, green, red and fluorescence image signals. These image signals obtained by the imaging device 15 are amplified by the amplifier 31, converted into digital signals by the A/D converter 32, and input to the input terminals of the memories 33R, 33G, 33B, and 33F.

After starting the process shown in the flowchart in FIG. 5, the CPU 41 provides the MIC 35 and the scan converter 34 with a synchronization signal received from the light source device controller 29 (S1). On the basis of this synchronization signal, the MIC 35 sequentially inputs a control signal to the control terminals of the memories sections 33B, 33G, 33R and 33F. When this control signal is input, each of the memories 33B, 33G, 33R and 33F receives a digital image signal currently output from the A/D converter 32 and retain it until the next control signal is input. Accordingly, the blue digital image signal is stored in the B memory 33B, the green digital image signal is stored in the G memory 33G, the red digital image signal is stored in the R memory 33R, and the fluorescence digital image signal is stored in the F memory 33F. In this manner, the blue, red, green and fluorescence digital image signals, each corresponding to one frame, are stored in the memories 33B, 33G, 33R and 33F, respectively. Then, the scan converter 34, which has received the above synchronization signal, reads out the image signal from each of memories 33B, 33G, 33R and 33F, and transmits these signals to the video capture device 42 in the PC 4 while synchronizing the signals. The video capture device 42 then separately accumulates the received blue, red, green and fluorescence digital image signals.

Next, the CPU 41 controls the video capture device 42 to store the blue, red, and green digital image signals which are temporarily held in the video capture device 42 itself into the memory M1 of the memory section 43(S2). Consequently, 24-bit RGB image data (normal image data), each pixel of which is composed of the red, green and blue digital image signals respectively having an 8-bit illuminance value, are synthesized in the memory M1.

Furthermore, the CPU 41 controls the video capture device 42 to store the F digital image signal which are temporarily held in the video capture device 42 itself into the memory MF of the memory section 43 (S3). As a result, F image data (fluorescence image data), each pixel of which is 8-bit illuminance value, is formed on the memory MF.

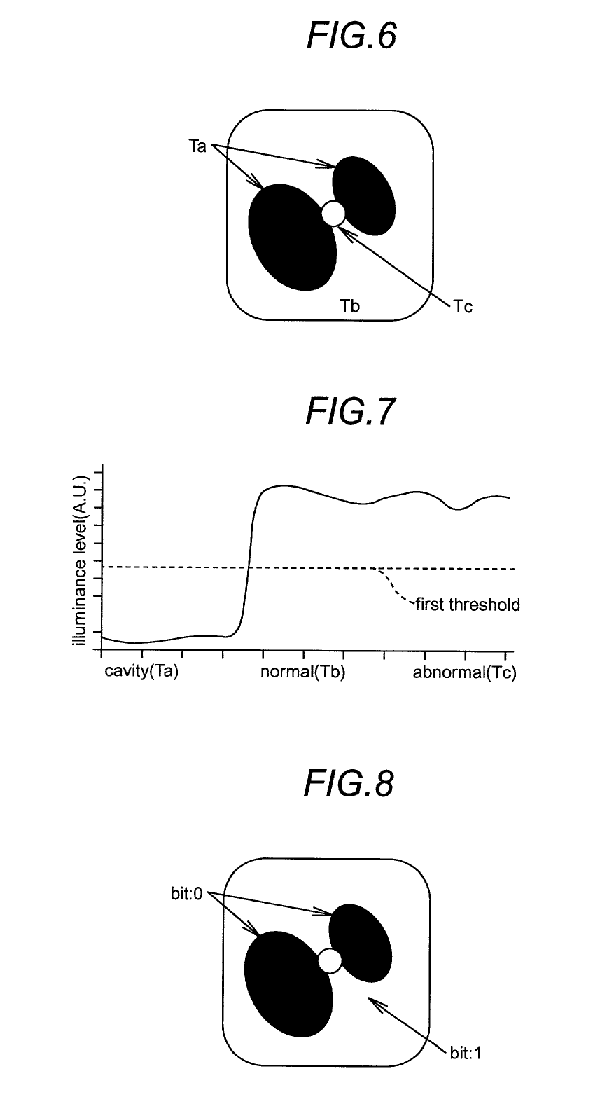

The CPU 41 subsequently copies the illuminance value of each pixel of the red digital image signal stored in the memory M1 to the memory M2 (S4). As a result, the image data stored in the memory M2 are such that a cavity portion Ta has a lower illuminance, whereas a wall portion Tb including a tumor site Tc has a higher illuminance as shown in FIGS. 6 and 7. At this time, the image data stored in the memory M2 is monochrome image data associated with the red light and corresponding to the reference image data.

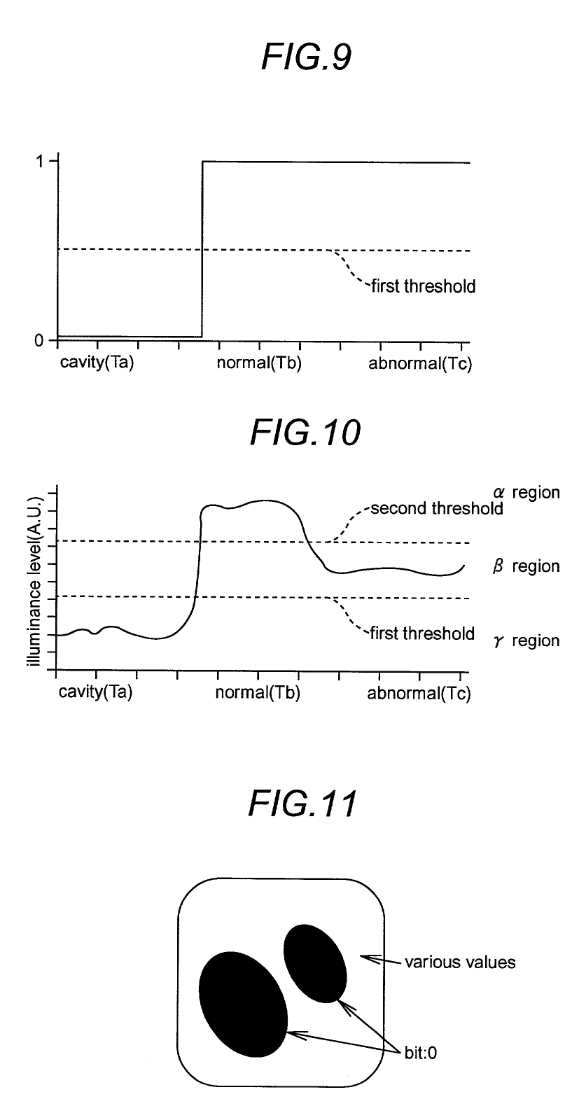

The CPU 41 compares the illuminance value of each pixel of the image data stored in the memory M2 with a predetermined first threshold (indicated by the broken line in FIG. 7) for binarization (S5). In other words, the CPU 41 changes all the 8 bits representing each of the illuminance values of pixels smaller than the first threshold value to “0.” On the other hand, the CPU 41 changes all the 8 bits representing each of the illuminance values of pixels that are equal to or larger than the first threshold value to “1.” This distinguishes the cavity portion Ta and the wall portion Tb from each other as shown in FIGS. 8 and 9, so that only pixels corresponding to wall portion Tb have the illuminance value “11111111.” An area consisting of the pixels in question corresponds to a predetermined region from which a specific region is extracted, as described later.

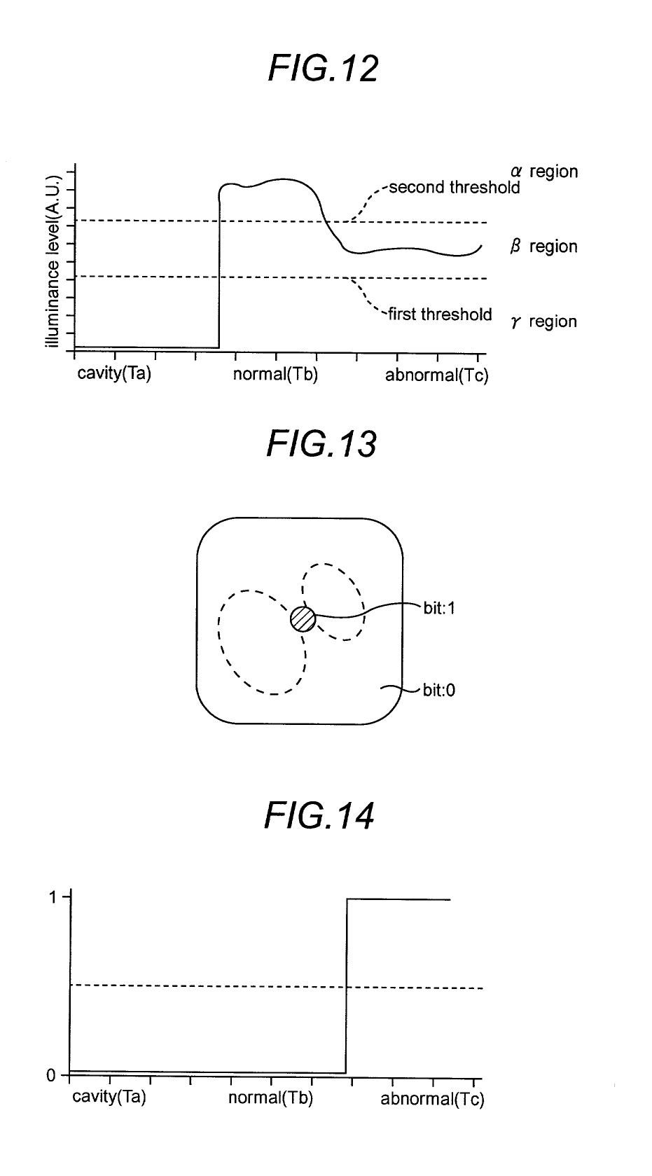

The memory MF stores the F image data, which has the distribution of illuminance values, each of which is binary value represented by 8 bits, as shown in FIG. 10. Thus, the CPU 41 performs a logical AND operation on a value of each bit constituting an illuminance value of each pixel stored in the memory M2 and a value of corresponding bit constituting an illuminance value of corresponding pixel stored in the memory MF, and overwrites the memory MF with the results of the operation (S6). Therefor, as shown in FIGS. 11 and 12, the image data remaining in the memory MF are such that a portion of the F image signal that corresponds to the cavity portion Ta is masked, while only the remaining portions corresponding to the wall portion Tb (including the tumor site Tc) remain unchanged. As shown in FIG. 12, the illuminance values of the portion of the image data stored in the memory MF that corresponds to a normal portion within the wall portion Tb are greater than those of the portion corresponding to the tumor site Tc.

The CPU 41 then compares the illuminance value of each pixel of the image signal stored in the memory MF with a predetermined second threshold (larger than the first threshold as shown in FIG. 12) for binarization (S7). In the graph in FIG. 12, an area having illuminance values equal to or larger than the second threshold is called “α,” while an area having illuminance values equal to or larger than the first threshold and smaller than the second threshold is called “β,” and an area having illuminance values smaller than the first threshold is called “γ.” In the process S7, the CPU 41 changes all 8 bits representing the illuminance values of pixels belonging to the β or γ area to “0.” On the other hand, the CPU 41 changes all 8 bits representing the illuminance values of pixels belonging to the α area to “1.” This extracts only the normal wall portion Tb, while excluding tumor site Tc, so that only the extracted normal site has the illuminance value “11111111.”

The CPU 41 then performs an exclusive OR operation on a value of each bit constituting an illuminance value of each pixel stored in memory M2 and a value of corresponding bit constituting an illuminance value of corresponding pixel stored in the memory MF, and overwrites the memory M2 with the results of the operation (S8). Therefor, as shown in FIGS. 13 and 14, the image data showing the shape and location of tumor site Tc remain in the memory M2. The portion of the image data retained in the memory M2 at this time that has the illuminance value “11111111” is the specific region.

The CPU 41 subsequently copies the normal image data stored in the memory M1 to an area of VRAM 44 corresponding to the left half of the screen (S9).

The CPU 41 then generates an image having a blue color superimposed on the specific region in the normal image. More specifically, the CPU 41 maps those pixels (showing the tumor site Tc) of the image data stored in memory M2 that have the illuminance value “11111111” onto the memory M1 and sets the color of the mapped pixels in the memory M1 to, for example, B (blue) (S10). This generates diagnostic image data, in which the area of the normal image data which corresponds to the tumor site Tc (abnormal site) is indicated with blue color, in the memory M1.

The CPU 41 then copies the diagnostic image data stored in the memory M1 to an area of VRAM 44 corresponding to the right half of the screen (S11).

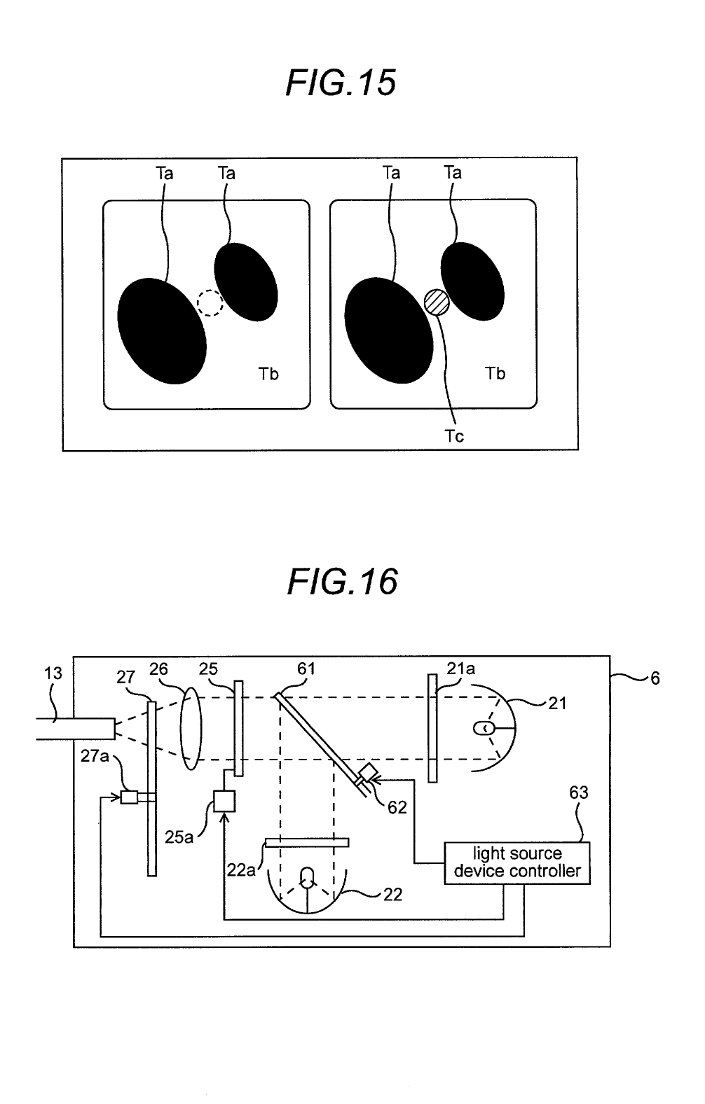

The CPU 41 outputs the image data stored in the VRAM 41, which includes the normal image data and the diagnostic image data to the D/A converter 36 (S12). The image data stored in the VRAM 44 is then supplied to the monitor 5 via the D/A converter 36. As a result, as shown in FIG. 15, a colored normal image based on the normal image data is displayed on the left half of the screen on the monitor 5, and a fluorescence diagnostic image based on the diagnostic image data is displayed on the right half of the screen on the monitor 5. The fluorescence diagnostic image is such a image that the specific region is superimposed with blue color on the normal image. In FIG. 15, the tumor site Tc is not indicated clearly in the normal image on the left half of the screen, whereas it is clearly shown in blue in the fluorescence diagnostic image on the right half of the screen.

The CPU 41 then returns the process to S1 to repeat the above processing. In this embodiment, a piece of image data for one screen is output from the VRAM 44, for example every 1/30 seconds, and an image based on each piece of the image data is displayed on the monitor 5. Thus, both of the normal image and the fluorescent diagnostic image are displayed on the monitor 5 as moving pictures. Thus, the operator can observe the subject of examination over a wide range while moving the endoscope 1. Additionally, since the diagnostic image is always displayed on the monitor 5 while the endoscope 1 is being moved, the operator can reliably and easily identify sites suspected as abnormalities such as a tumor.

### Second Embodiment

A video endoscope system according to a second embodiment differs from the video endoscope system according to the first embodiment only in the configuration of the light source device 6. FIG. 16 shows a structure of the light source device 6 in the video endoscope system of the second embodiment. In the light source device 6, the white light source 21, the excitation light source section 22, the diaphragm 25, the diaphragm control 25a, the condenser lens 26, the rotating wheel 27 and the motor 27a are the same as those of the light source device 2 in the first embodiment. However, the light source device 6 has an optical path switching wheel 61, a second motor 62 and a light source device controller 63 instead of the shutters 23 and 28, the shutter driving sections 23a and 28a, the prism 24 and the light source device controller 29 of the first embodiment.

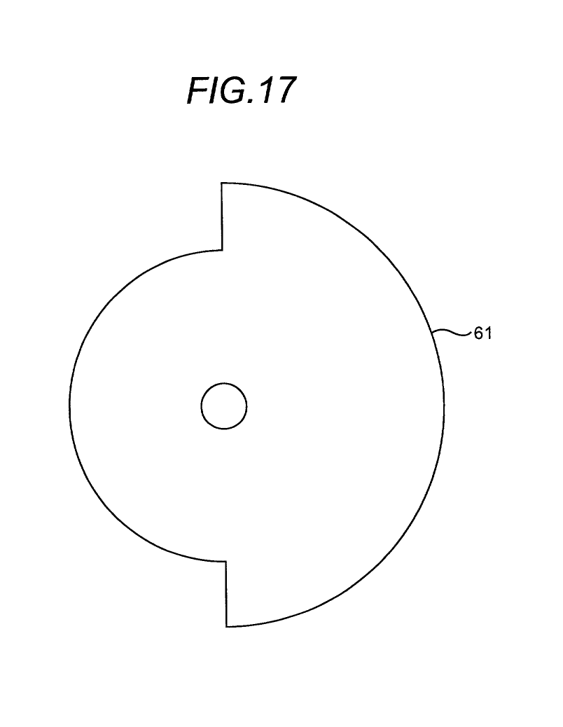

The optical path switching wheel 61 is disposed at the location where the prism 24 is disposed in the first embodiment. The optical path switching wheel 61 is formed to have a shape in which a larger-diameter semicircle and a smaller-diameter semicircle are integrally joined as shown in FIG. 17. The optical path switching wheel 61 functions as the reflection member which blocks the white light, while reflecting the excitation light. the optical path switching wheel 61 is coaxially connected to a drive shaft of the second motor 62 as a switching mechanism. A central axis of the optical path switching wheel 61 is disposed within a plane containing both of the optical axes of the reflectors in the light source sections 21 and 22. Furthermore, the optical path switching wheel 61 is arranged so that only its larger-diameter semicircle can pass through the position where the white light and the excitation light emitted from the light sources 21 and 22 cross each other. If the smaller-diameter semicircle of the optical path switching wheel 61 approaches the point at which the white light and the excitation light cross, the optical path switching wheel 61 does not interfere with the white light nor the excitation light. In this condition, the white light advancing without being interfered by the optical path switching wheel 61 travels to the diaphragm 25, at the same time, the excitation light also advancing without being interfered by the optical path switching wheel 61 does not travel to the diaphragm 25. Consequently, only the white light reaches the diaphragm 25. The amount of the white light is adjusted by the diaphragm 25, and the white light is then converged onto the proximal end face of the light guide 13 via the wheel 27 by the condenser lens 26. On the other hand, while the larger-diameter portion of the optical path switching wheel 61 passes through the point at which the white light and the excitation light cross, the excitation light is reflected by the optical path switching wheel 61 toward the diaphragm 25, at the same time, the white light is blocked by the optical path switching wheel 61. Consequently, only the excitation light reaches the diaphragm 25. The amount of the excitation light is adjusted by the diaphragm 25, and the excitation light is then converged onto the proximal end face of the light guide 13 via the wheel 27 by the condenser lens 26.

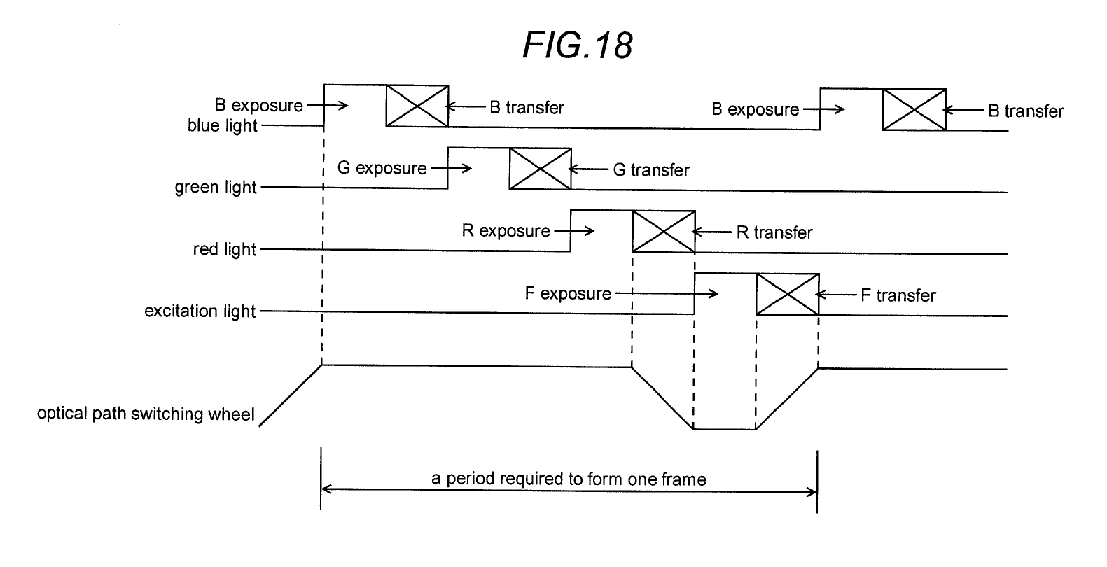

Accordingly, while the optical path switching wheel 61 is rotated, the white light and the excitation light are emitted alternately through the condenser lens 26. Since the optical path switching wheel 61 is rotated at a constant speed by the motor 62, the duration for which the white light is emitted through the condenser lens 26 equals the duration for which the excitation light is emitted through the condenser lens 26. FIG. 18 is a timing chart for the illuminating light and movement of the optical path switching wheel 61. In this figure, the upper portion of the chart for the optical path switching wheel 61 shows a period when the white light passes through the condenser lens 26, while the lower portion of the chart for the optical path switching wheel 61 shows a period when the excitation light passes through the condenser lens 26. Although the length of the upper portion is indicated as to be longer than that of the lower portion in this figure, for the sake of illustration, they are actually equal to each other.

While the optical path switching wheel 61 rotates, the wheel 27 also rotates synchronously thereto. Accordingly, while the white light is being transmitted through the condenser lens 26, it is sequentially converted into blue, green and red light by the corresponding filters of the wheel 27. On the other hand, while the excitation light is being transmitted through the condenser lens 26, it is transmitted through the wheel 27 and then enters the light guide 13. Thus, the blue, green and red light and the excitation light are sequentially and repeatedly incident on the light guide 13. The period during which the blue light guided by the light guide 13 is emitted through the light distribution lens 11 corresponds to a “B exposure” period for the imaging device 15. Immediately after the “B exposure” period, the charges accumulated in the imaging device 15 are transferred over a fixed transfer time, which is called a “B transfer” period. The period during which the green light guided by the light guide 13 is emitted through the light distribution lens 11 corresponds to a “G exposure” period for the imaging device 15. Immediately after the “G exposure” period, the charges accumulated in the imaging device 15 are transferred over the above transfer time, which is called a “G transfer” period. The period during which the red light guided by the light guide 13 is emitted through the light distribution lens 11 corresponds to an “R exposure” period for the imaging device 15. Immediately after the “R exposure” period, the charges accumulated in the imaging device 15 are transferred over the above transfer time, which is called an “R transfer” period. Further, the period when the excitation light guided by the light guide 13 is emitted through the light distribution lens 11 corresponds to an “F exposure” period for the imaging device 15. Immediately after the “F exposure” period, the charges accumulated in the imaging device 15 are transferred over the above transfer time, which is called an “F transfer” period. During the period from the start of the “B exposure” period to the end of the “R exposure” period, the optical path switching wheel 61 has its smaller-diameter semicircle located close to the point at which the white light and the excitation light cross. During the “F exposure” period, the optical path switching wheel 61 has its larger-diameter semicircle pass through that point. Although FIG. 18 shows the period from the start of the “B exposure” period to the end of the “R exposure” period and the “F exposure” period to be different in length (duration), they are actually equal to each other.

As described above, the light source device 6 of the second embodiment has the optical path switching wheel 61, so that the shutters 23 and 28, the prism 24, and so on as used in the first embodiment can be omitted. Accordingly, this video endoscope system can obtain normal and diagnostic images using a simpler configuration than that of the first embodiment.

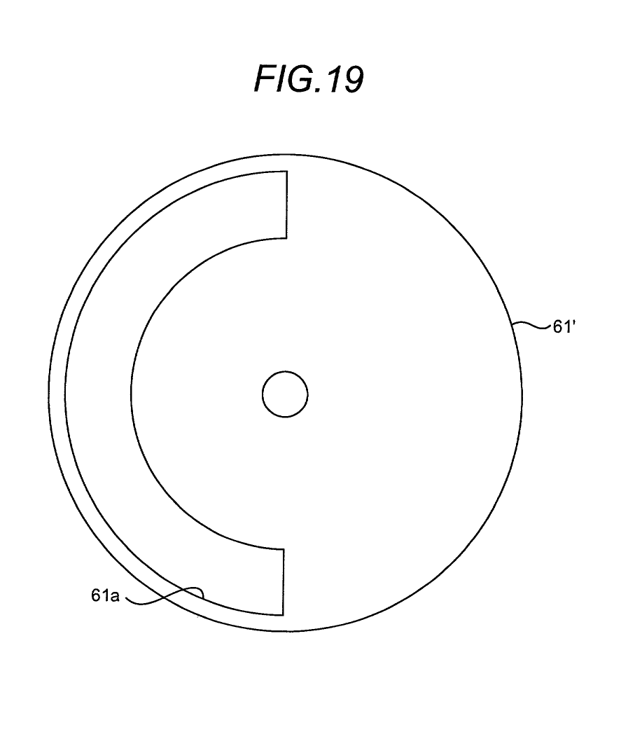

The light equipment 6 of the second embodiment may has an optical path switching wheel 61′ shown in FIG. 19, in place of the optical path switching wheel 61 shown in FIG. 17. The optical path switching wheel 61′ is a disc-shaped mirror on which an opening 61a is formed. This opening 61a is shaped in arc bounded by a convex arc edge on a first concentric circle having a slightly smaller radius than the outer peripheral of the optical path switching wheel 61′, a convex arc edge on a second concentric circle having a smaller radius than the first concentric circle, and a pair of radical edges. The opening 61a may be fitted with a transparent member transmitting at least the excitation light. The opening 61a on the optical path switching wheel 61′ corresponds to a transparent portion, while the other portions correspond to a reflection portion.

The video endoscope system according to the present invention can obtain, as a moving picture, not only normal images but also fluorescence images. Thus, the operator can observe the subject of examination over a wide range through the normal and fluorescence images, thereby achieving more precise screening. The image-processing section of this video endoscope system configured to extract the diagnostic images showing a specific region suspected of disease as a moving picture, the operators can find diseased sites easily and without fail.

What is claimed is:

1. An video endoscope system comprising:
an illumination optical system for illuminating a subject;
a light source device for emitting visible light and excitation light that excites living tissue to cause fluorescence, and for alternately switching between the visible light and the excitation light to introduce them into the illumination optical system;
an objective optical system for focusing those components of light from a surface of said subject other than the excitation light to form an image of the surface of the subject;
an imaging device for picking up the image formed by said objective optical system to convert it into an image signal; and
an image processor for generating normal image data to display a normal image of the subject as a moving picture, on the basis of a portion of the image signal obtained by said imaging device which corresponds to a period, when the visible light is introduced into the illumination optical system, and for generating fluorescence image data to display a fluorescence image of the subject as a moving picture, on the basis of a portion of the image signal corresponding to a period, when the excitation light is introduced into said illumination optical system.

2. A video endoscope system according to claim 1, wherein said light source device has
a visible light source for emitting the visible light,
an excitation light source for emitting the excitation light, and
a light source switching section for alternately switching between the visible light emitted from said visible light source and the excitation light emitted from said excitation light source to introduce them into said illumination optical system.

3. A video endoscope system according to claim 2, wherein said light source switching section has
a first shutter capable of blocking visible light emitted from said visible light source,
a second shutter capable of blocking the excitation light emitted from said excitation light source, and
a switching driving mechanism for causing said second shutter to retract from the optical path of the excitation light and said first shutter to block the visible light, and for causing said first shutter to retract from the optical path of the visible light and said second shutter to block the excitation light.

4. A video endoscope system according to claim 2, wherein said visible light source and said excitation light source are arranged so that the optical paths of light emitted from these light sources cross to each other at a predetermined intersection,
wherein said illumination optical system is arranged at a point beyond said intersection on the optical path of the light emitted from one of the light sources, and
wherein said light source switching section has a reflection member that can be inserted into said intersection to block the light emitted from said one of the light sources and to reflect the light emitted from the other light source toward said illumination optical system, and a switching driving mechanism for intermittently inserting the reflection member into said intersection.

5. A video endoscope system according to claim 4, wherein the reflection member of said light source switching section is a disclike reflector that is notched near a peripheral portion thereof, and
wherein said switching driving mechanism rotates the reflection member so that a notched portion thereof and other portion thereof are alternately inserted into said intersection.

6. A video endoscope system according to claim 4, wherein the reflection member of said light source switching section is a disclike reflector that has a transparent portion transmitting light emitted from said one of the light sources and a reflection portion for reflecting light emitted from the other light source, and
wherein said switching driving mechanism rotates the reflection member so that the transparent portion and reflection portions of said reflection member are alternately inserted into said intersection.

7. A video endoscope system according to claim 1, wherein said image processor extracts a specific region having an illuminance value within a predetermined range from said fluorescence image data to generate diagnostic image data showing the specific region.

8. A video endoscope system according to claim 1, wherein said image processor extracts a specific region having an illuminance value within a predetermined range from said fluorescence image data to generate diagnostic image data in which a portion of said normal image data corresponding to the said specific region is shown in a predetermined color.

9. A video endoscope system according to claim 1, wherein said image processor extracts reference image data from said normal image data,
extracts a particular region having an illuminance value equal to or larger than a first threshold, from the reference image data,
extracts a specific region from a region of said fluorescence data which correspond to said particular region, said specific region having an illuminance value smaller than a second threshold and larger than said first threshold, and
generates diagnostic image data to display a diagnostic image in which a portion of said normal image data corresponding to said specific region is shown in a predetermined color.

10. A video endoscope system according to claim 9, wherein said reference image data is monochrome image data.

11. A video endoscope system according to claim 2, wherein the visible light source section of said light source device emits white light, and
wherein said light source device further has
a wheel shaped in a disc and holding a blue filter transmitting only blue light, a green filter transmitting only green light a red filter transmitting only red light, and a transparent member transmitting at least the excitation light, along its circumference, and
a driving section for rotating said wheel so that the filters held on said wheel are sequentially inserted into the optical path between said light source switching section and said illumination optical system while said light source switching section is switching to the white light and so that the transparent member held on said wheel is inserted into the optical path while said light source switching section is switching to the excitation light.

12. A video endoscope system according to claim 11, wherein said image processor generates the normal image data on the basis of an image signal obtained by said imaging device while the blue filter held on said wheel is inserted into said optical path, an image signal obtained by said imaging device while the green filter held on said wheel is inserted into said optical path, and an image signal obtained by said imaging device while the red filter held on said wheel is inserted into said optical path.

13. A video endoscope system according to claim 12, wherein said image processor generates reference image data on the basis of the image signal obtained by said imaging device while the red filter held on said wheel is inserted into said optical path,
extracts a particular region having an illuminance value equal to or larger than a first threshold, from the reference image data,
extracts a specific region from a region of said fluorescence data corresponding to said particular region, said specific region having an illuminance value smaller than a second threshold and larger than said first threshold, and
generates diagnostic image data to display a diagnostic image, in which a portion of said normal image data corresponding to said specific region is shown in a predetermined color.

14. A video endoscope system according claims 1, further comprising a monitor for displaying a moving picture according to the image data output from said image processor.
